(19) United States
(12) Patent Application Publication
(10) Pub. No.: US 2025/0298122 A1
(43) Pub. Date: Sep. 25, 2025

(54) TRANSCEIVER AND METHOD FOR CHARACTERIZING A TRANSCEIVER

(71) Applicant: dSPACE GmbH, Paderborn (DE)

(72) Inventor: Niklas LANGE, Paderborn (DE)

(73) Assignee: dSPACE GmbH, Paderborn (DE)

(21) Appl. No.: 19/083,320

(22) Filed: Mar. 18, 2025

(30) Foreign Application Priority Data
Mar. 20, 2024 (DE) 102024107887.1

(51) Int. Cl. G01S 7/40; G01S 13/931

(52) U.S. Cl. CPC G01S 7/4052; G01S 13/931

(57) ABSTRACT

A transceiver for transmitting and receiving electromagnetic signals, wherein the electromagnetic signals are intended for exchange with an object detection sensor, wherein the transceiver has an analog part. The analog part has a transmitting part and a receiving part. A test device is set up to transmit a first test signal to the transmitting part, and the transmitting part is set up to generate a first electromagnetic signal from the first test signal and transmit it. The receiving part is set up to receive a second electromagnetic signal derived from the first electromagnetic signal, convert it into a second test signal and transmit it to the test device. The test device is set up to determine at least one parameter characterizing the analog part as a function of the first and second test signals. A method for characterizing a transceiver is also provided.

This nonprovisional application claims priority to German Patent Application No. 10 2024 107 887.1, which was filed in Germany on Mar. 20, 2024, and which is herein incorporated by reference.

### BACKGROUND OF THE INVENTION

### Field of Invention

The application relates to a transceiver for transmitting and receiving electromagnetic signals and a method for characterizing a transceiver for transmitting and receiving electromagnetic signals.

### Description of the Background Art

Transceivers can be used as simulation systems for object detection sensors. Such an object detection sensor can be designed, for example, as a vehicle sensor that works with electromagnetic waves. Examples of such a vehicle sensor are radar sensors or LiDAR sensors. The object detection sensors are tested by the transceiver receiving electromagnetic signals from the object detection sensor and sending electromagnetic signals back to it, which are perceived by the object detection sensor as echoes of objects in road traffic.

### SUMMARY OF THE INVENTION

It is therefore an object of the present to provide a transceiver for transmitting and receiving electromagnetic signals, the electromagnetic signals are intended to be exchanged with an object detection sensor. Electromagnetic signals may, for instance, include radar signals.

The transceiver has an analog part, wherein the analog part has a transmitting part and a receiving part. A test device is set up to transmit a first test signal to the transmitting part. The transmitting part is set up to generate a first electromagnetic signal from the first test signal and transmit it. The receiving part is set up to receive a second electromagnetic signal derived from the first electromagnetic signal, convert it into a second test signal, and transmit it to the test device. The test device is set up to determine at least one parameter that characterizes the analog part as a function of the first and the second test signals.

Such a test device can be used to characterize the analog part of the transceiver. The test device may be part of the transceiver, enabling a self-test for the analog part. Particularly, the test device may have a digital part that generates the first and second test signals as digital signals.

In the method for characterizing a transceiver for transmitting and receiving electromagnetic signals, the electromagnetic signals are intended to be exchanged with an object detection sensor and the transceiver has an analog part which has a transmitting part and a receiving part. The method comprises:

A test device transmits a first test signal to the transmitting part.

The transmitting part generates a first electromagnetic signal from the first test signal and transmits the first electromagnetic signal.

The receiving part receives a second electromagnetic signal derived from the first electromagnetic signal, converts the second electromagnetic signal into a second test signal, and transmits the second test signal to the test device.

As a function of the first and the second test signal, the test device determines at least one parameter characterizing the analog part.

This makes it possible to characterize the analog part of the transceiver using the test device and to determine and make available at least one parameter characterizing the analog part. The characterizing parameter(s) can then be taken into account, for example, during the exchange of the electromagnetic signals with an object detection sensor.

The test device can be part of the transceiver, which then enables the transceiver to perform a self-test of its analog part. In particular, the first and second test signals can be generated by the test device as digital signals.

This can then enable a more uniform operation of the analog part over longer periods of time. Possibilities for fault diagnosis are also possible in this way. In particular, the transceiver or the corresponding method may prevent such transceivers from having to be re-measured after a certain period of time in the laboratory and, if necessary, parameters from having to be readjusted. This ensures a high level of customer benefit, as the transceivers no longer need to be taken to a laboratory, but rather the characterization of the analog part can be performed during operation.

The transceiver for transmitting and receiving electromagnetic signals may have a simulation device connected by means of the electromagnetic signals to an object detection sensor to be tested. The simulation device can then serve, for example, as an object simulator for the object detection sensor. For this purpose, in addition to the necessary electronics in the transmitting part for generating electromagnetic signals and in the receiving part for receiving electromagnetic signals, the transceiver may also include a manipulation device that evaluates the received electromagnetic signal in order to test the sensor for object detection based on this evaluation and additional data. The other data are, for example, predefined object scenarios, i.e., which objects should be in the simulated environment for the object detection sensor. The direction of movement and speed and, if necessary, a change in this speed may also be included in this data. The electromagnetic signals can be radar signals or LiDAR signals. The object detection sensor can be a radar sensor or a LiDAR sensor. For transmitting and receiving optical signals, the transmitting part and the receiving part can have corresponding optoelectronic converters. For example, a laser can be provided in the transmitting part, and photosensitive components can be provided in the receiving part.

The manipulation device may, for example, comprise the test unit. In examples, the manipulation device is designed as a digital part that can perform not only the tasks of the manipulation device but also those of the test device. For example, a test or characterization operating mode may be provided, in which the manipulation device then functions as a test device. For example, a simulation operating mode may be provided, in which the manipulation device acts as a simulation device and, in particular, as an object simulator for the object detection sensor.

The transceiver has an analog part that has a transmitting part and a receiving part. The transmitting part is intended to generate and send a first electromagnetic signal, for example, a high-frequency signal, e.g., in the microwave range or a LIDAR signal, from a first test signal.

For this purpose, the transmitting part may have amplifiers as well as mixers and filters. Mixers, for example, are designed to modulate the frequency of the electromagnetic signal to a signal of a transmitting frequency. If the first test signal is generated by the test device as a digital signal, it can be converted into an analog signal by means of a digital-to-analog converter, which can be processed by the transmitting part. The receiving part is appropriately set up to filter, amplify, and mix the second electromagnetic signal into an intermediate frequency that allows for easier processing of the electromagnetic signal. If the test device has a digital part, an analog-to-digital converter may also be provided, which converts the second electromagnetic signal into a digital signal, which can be digitally processed by the test device as a second test signal.

The first test signal that enters the transmitting part is transmitted by a test device. The first test signal can be generated by the test device, for example, or read out from a memory, for example. The test device may have a digital part or be designed as a digital part. The digital part has digital circuits, for example one or more processors. However, it is also possible that the first test signal is present in analog form and is transmitted analog to the transmitting part. For example, it can be fed to the transmitting part from the outside via the test device or read out from a memory by the test device.

As a function of the first and the second test signal, the test device will then determine at least one parameter characterizing the analog part. For example, if the test signal is also analog, corresponding evaluation circuits are provided. If the test device is digitally designed, the first and second test signals can also be digital and the evaluation of the first and second test signals to determine the characterizing parameter can then be carried out by appropriate digital circuits or by algorithms that are executed on a processing unit. In particular, the test device may also be provided separately from the transceiver, or it may be provided in a structural unit with the transceiver.

The characterizing parameters can be, for example, parameters that are used to describe the signal behavior of electrical and/or optical components and networks by means of wave sizes.

However, other alternative values can also be used as characterizing parameters that describe the transmission behavior of the analog part.

The test device can be set up to determine and store at least one operating parameter of the analog part, as a function of the at least one characterizing parameter, wherein the at least one operating parameter comprises a gain value and/or a delay and/or an isolation. This means that at least one operating parameter is determined from the parameter characterizing the analog part and stored accordingly, wherein this operating parameter includes an amplification, a delay, or an isolation. Amplification refers to an increase or attenuation of an amplitude of the first and/or second electromagnetic signal. The delay refers to a time delay of the first and/or the second electromagnetic signal. Isolation is a measure of crosstalk between the transmit path and the receive path. The transmit path refers to the signal path through which the first electromagnetic signal passes in the transmitting part. The receive path is the signal path through which the second electromagnetic signal passes in the receiving part.

Over time, the analog part can lose the originally set gain or exhibit a different delay than originally due to aging effects or temperature effects, for example, or the isolation between the transmitting part and the receiving part may change. By means of the described transceiver with test device and the described method, the determined operating parameter can be taken into account in the subsequent use of the transceiver. This ensures consistent behavior of the analog part.

The electromagnetic signals intended for exchange with the object detection sensor may depend on the at least one characterizing parameter and/or the at least one operating parameter. For example, the amplitude, phase, and/or frequency of the electromagnetic signals may depend on the at least one operating parameter.

The test device can be designed to determine the at least one characterizing parameter through system identification of the analog part using the first and second test signals. In this context, system identification refers to the systematic determination of the qualitative dependence of the system's output variables on its input variables. The input variable is the first test signal, the output variable is the second test signal, and the system is the analog part. The mathematical methods used in this process can be deterministic or stochastic. A neural network may also be applied, for example.

By means of system identification, characterizing parameters can be determined, such as the following parameters: The transmission factor provides information about the amplification or attenuation of the first test signal by the analog part. The scattering parameter provides information about the signal component that cross-talks from the output of the analog part to its input. The scattering parameter may also be referred to as isolation. The isolation determines which dynamic range of the analog part may be utilized.

The test device can be configured to determine the at least one characterizing parameter in the frequency range and transform it into the time range. The advantage of this example is that some determinations in the time range can be mathematically simpler than, for example, in the frequency range.

Furthermore, it is proposed that the test device be configured to transform the at least one characterizing parameter of the analog part from the frequency range into the time range and to determine the at least one operating parameter based on the at least one characterizing parameter of the analog part, which has been transformed in the time range.

The second electromagnetic signal can be derived from the first electromagnetic signal via a predefined reflection standard. A predefined environment can be created via the predefined reflection standard to generate the second electromagnetic signal in a defined and known form via this reflection. This enables a simple setup for determining the at least one parameter characterizing the analog part. Particularly, it simplifies how the transceiver may be configured and arranged in relation to the defined reflection standard to determine the at least one parameter characterizing the analog part.

The predefined reflection standard may include a resistance match, an open circuit, a short circuit, or a reflection of the first electromagnetic signal on a reflector or corner reflector. The resistance match may, for example, be a wave impedance match. Predefined reflections can via the reflector or corner reflector.

By using predefined reflection standards, the measurement may be traced back to these standards. This enables calibration or recalibration of the analog part.

The transceiver can be configured to determine a crosstalk signal when exchanging electromagnetic signals with the sensor for object detection, as a function of the at least one characterizing parameter. The crosstalk signal may optionally be compensated for by the transceiver. Crosstalk signals may occur between the transmitting and receiving parts. These represent undesirable mutual interference of otherwise independent signal channels. Therefore, this signal disruption needs to be determined and ideally compensated for. The crosstalk signal especially depends on the scattering parameter and may be compensated based on the previously determined scattering parameter.

Different predefined reflection standards may be defined by the distance of the corner reflector from the transceiver. Thus, it is possible to achieve the most precise characterization of the analog part through repeated measurements at the corner reflector, which is placed at different distances from the transceiver during the repetitions.

The method may be carried out using a predefined reflection standard. Alternatively, or additionally, the method may be performed multiple times in succession, each time with a different predefined reflection standard. It is therefore possible, as a function of the desired reliability or accuracy, to work with a single predefined reflection standard or with different reflection standards consecutively. When using system identification, for example, three predefined reflection standards may be used to determine three characterizing parameters or a complete error network.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limited of the present invention, and wherein:

FIG. 1 shows a block diagram of the transceiver with test device;

FIG. 2 shows a test environment with the transceiver;

FIG. 3 shows a flowchart of a method for characterizing the transceiver;

FIG. 4 shows a simplified equivalent circuit diagram of the transceiver with test device;

FIG. 5 shows an amplitude-frequency diagram;

FIG. 6 shows an amplitude-time diagram;

FIG. 7 shows a simulation environment; and

FIG. 8 shows another block diagram of the transceiver in a simulation operating mode.

### DETAILED DESCRIPTION

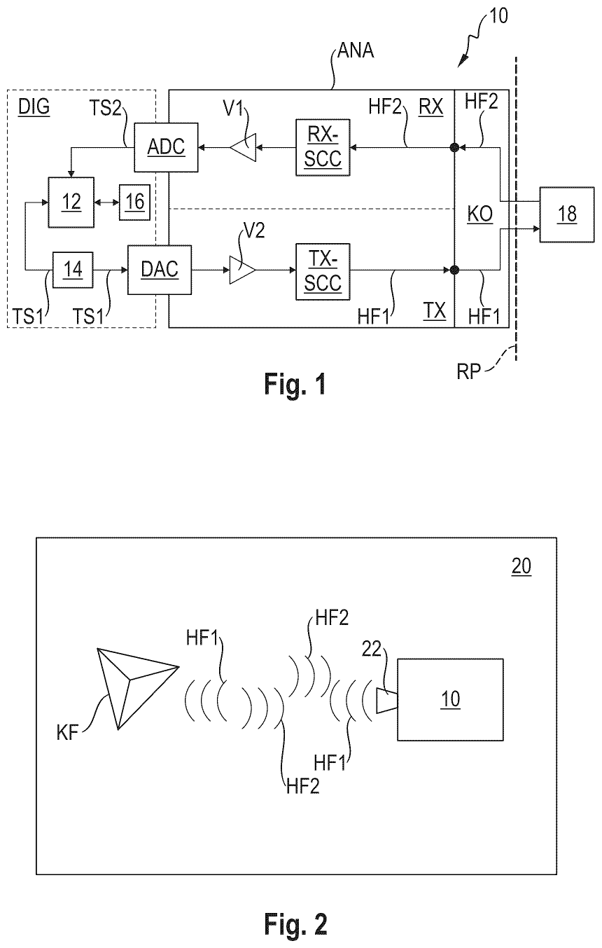

FIG. 1 shows a block diagram of a transceiver 10 with an analog part ANA and a test device DIG. In the example shown, the test device DIG is designed as a digital part of the transceiver 10.

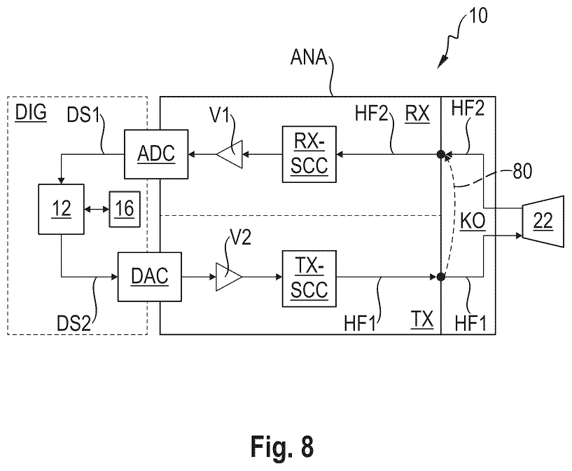

The test device DIG also serves as a simulation device for object simulation if the transceiver 10 is in a simulation operating mode (FIG. 7, FIG. 8).

FIG. 1 shows the transceiver 10 in a characterization operating mode. In the characterization operating mode, at least one characterizing parameter SXX, e₀₁e₁₀, ent of the analog part ANA is determined.

The analog part ANA has a coupler KO through which the electromagnetic signals are transmitted to a reflection standard 18. The analog part ANA is monostatic, i.e., there is an interface, namely the coupler KO, and both transmission signals, i.e., first electromagnetic signals HF1, and reception signals, i.e., second electromagnetic signals HF2, are transmitted via this interface. The coupler KO ensures that the two signals can be separated from each other. A reference plane RP is provided behind the coupler KO on the side facing away from the analog part ANA. The reference plane RP represents an imaginary surface used as a basis for calculations or, in this case, measurements-particularly for system identification—as well as for the specific characterizing parameters and operating parameters.

In the test device DIG, the first test signal TS1 is generated by the signal generator 14. The generation by the signal generator 14 includes the option for the first test signal TS1 to be loaded from a memory 16 by means of the signal generator 14 according to a predefined specification. Optionally, the signal generator can also modify the first test signal TS1 loaded from memory 16. The generation by means of the signal generator 14 also optionally includes the ability for the first test signal TS1 to be generated by means of the signal generator 14, for example, on demand. The generation of the first test signal TS1 can be controlled, for example, by means of a processor 12 of the test device DIG. The first test signal TS1 is transmitted to a digital-to-analog converter DAC, which connects the test device DIG with the analog part ANA. In this case, the digital-to-analog converter DAC is assigned to the analog part ANA. However, it is also possible to assign it to the test device DIG or to provide it as a separate element of the transceiver 10.

The first test signal TS1 is also transmitted to the processor 12. The processor 12 determines the at least one parameter SXX, e₀₁, e₁₀, e₁₁ characterizing the analog section ANA using the first test signal TS1 and the second test signal TS2. To determine the at least one parameter SXX, e₀₁, e₁₀, e₁₁ characterizing the analog section ANA, the processor performs, for example, a system identification using the first test signal TS1 and the second test signal TS2.

The first test signal TS1, converted into an analog signal by the digital-to-analog converter DAC, is amplified in the transmitting part TX by the amplifier V2 and converted into the first electromagnetic signal HF1, which is a high-frequency signal, in the transmitting transducer TX-SCC. Other components, such as mixers, can be included in this signal path. In the transmitting transducer TX-SCC, the first test signal TS1, which has been converted into an analog signal, is up-mixed to a higher frequency by a mixer, for example, wherein the first electromagnetic signal HF1 is then transmitted to a coupler KO. The coupler KO then outputs the first electromagnetic signal HF1 to the reflection standard 18. Via the reflection standard 18, a second electromagnetic signal HF2 is derived from the first electromagnetic signal HF1. This is coupled into the analog part ANA by means of the coupler KO. It then enters the receiving part RX. In the receiving transducer RX-SCC, the second electromagnetic signal HF2 is downmixed into an intermediate frequency. The signal converted in this way is then amplified by the amplifier V1 and enters an analog-to-digital converter ADC, which digitizes the second electromagnetic signal HF2 and outputs it as the second test signal TS2 to the test device DIG. This signal path can also include other components, such as mixers.

The second test signal TS2 enters the processor 12 of the test device DIG in the test device DIG. The processor 12 performs the method for characterizing the analog part ANA and derives from the first and second tests signals TS1, TS2, the at least one parameter SXX, e₀₁e₁₀, e₁₁, which characterizes the analog part ANA. The processor 12 can store intermediate results, but also the final result in the memory 16. The processor 12 can determine the characterizing parameter SXX, e₀₁e₁₀, e₁₁, e.g., in the frequency range and transform it into the time range. The operating parameters can then be determined from the data obtained.

FIG. 2 shows a test environment 20 with the transceiver 10, which has an antenna 22 for transmitting and receiving the first and second electromagnetic signals HF1, HF2. In the test environment, the transceiver 10 is operated in the characterization operating mode.

The first electromagnetic signal HF1 is sent in the direction of a corner reflector KF. At the corner reflector KF, a reflection occurs, so that the first electromagnetic signal HF1 is transformed into the reflected second electromagnetic signal HF2. This is reflected in the direction of the transceiver 10. The second electromagnetic signal HF2 is received via the antenna 22 and processed in the manner described above in order to determine the at least one parameter SXX, e₀₁e₁₀, e₁₁ characterizing the analog part.

Instead of the corner reflector KF, other reflection standards 18 may also be provided, such as a different type of reflector, impedance matching, or an open circuit or short circuit. In particular, the impedance matching, the open circuit or the short circuit may be connected directly to the coupler KO, so that no antenna 22 is required for these reflection standards 18.

In particular, it is also possible to perform several measurements in a row with different reflection standards 18. With several different reflection standards 18, several unknown characterizing parameters SXX, e₀₁e₁₀, e₁₁ can be determined with better accuracy.

Particularly, it is also possible to carry out several measurements in a row, in which the corner reflector KF has different distances from the transceiver 10. In this case, the corner reflector KF corresponds to a different reflection standard 18 if it has a different distance to the transceiver 10.

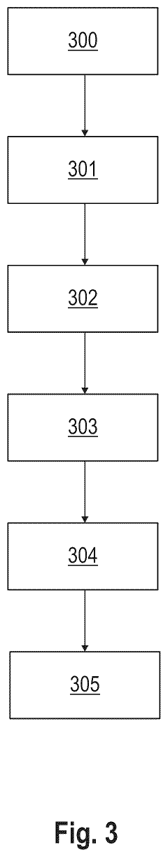

FIG. 3 shows a flowchart of the method for characterizing the transceiver 10, particularly the analog part ANA of the transceiver 10 for transmitting and receiving electromagnetic signals HF1, HF2.

In method step 300, the test device DIG generates the first test signal TS1 and transmits it to the transmitting part TX. For example, the first test signal TS1 may be a sine wave signal that is used in repeated measurements with different frequencies.

In method step 301, the transmitting part TX generates the first electromagnetic signal HF1 from this first test signal TS1. For this purpose, the first test signal TS1 is first converted into an analog signal by the digital-to-analog converter DAC, amplified by the amplifier V2 and converted into the first electromagnetic signal HF1 by the transmitting transducer TX-SCC. This signal path can also contain other components such as mixers.

In method step 302, the first electromagnetic signal HF1 is sent via the coupler KO and, optionally, the antenna 22.

In method step 303, the receiving part RX receives the second electromagnetic signal HF2, which is derived from the first electromagnetic signal HF1. This derivation is made by means of a predefined reflection standard 18. The derivation, specifically the conversion of the first electromagnetic signal HF1 to the second electromagnetic signal HF2, is known by means of the predefined reflection standard 18.

In method step 304, the receiving part RX converts the second electromagnetic signal HF2 into a second test signal TS2. The second test signal TS2 is transmitted to the test device DIG.

In method step 305, the determination of the at least one parameter characterizing the analog part ANA SXX, e₀₁e₁₀, e₁₁ is carried out as a function of the first and the second test signals TS1, TS2.

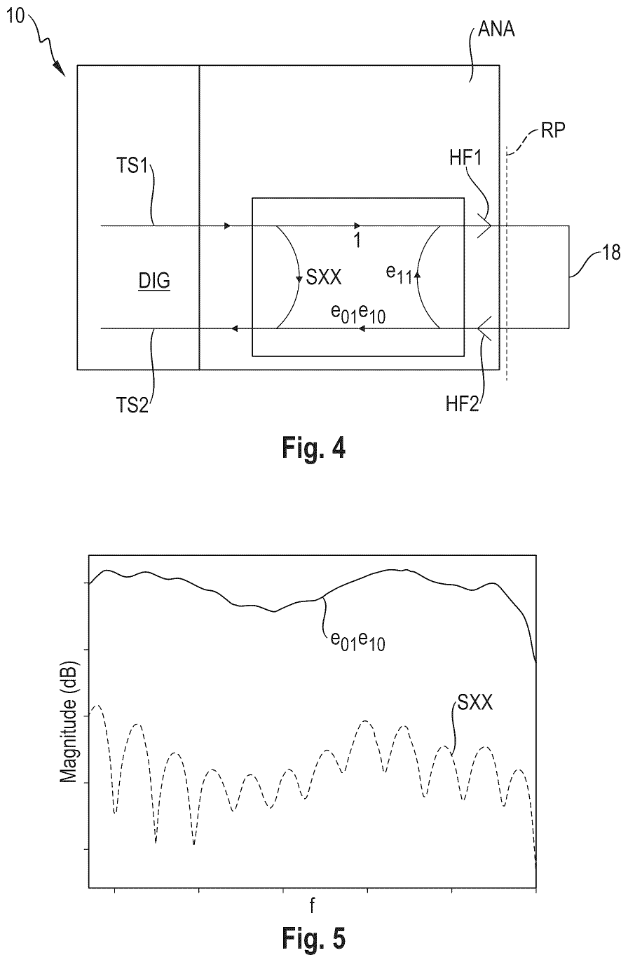

FIG. 4 shows the transceiver 10 in an equivalent circuit diagram. The analog part ANA is represented by a system equivalent circuit diagram. From the test device DIG, the first test signal TS1 is in turn transmitted to the analog part ANA. The analog part ANA is characterized in the sense of system identification by a scattering parameter SXX and other characterizing parameters e₀₁e₁₀, e₁₁.

The first test signal TS1 passes through the analog part ANA and is output as the first electromagnetic signal HF1 at the reference plane RP. The reflection standard 18 converts the first electromagnetic signal HF1 into the second electromagnetic signal HF2. Via the reflection at the reflection standard 18, the second electromagnetic signal HF2 is derived from the first electromagnetic signal HF1.

The second electromagnetic signal HF2 is coupled back into the analog part ANA and then arrives at the test device DIG as the second test signal TS2.

The behavior of the analog part ANA during the transmission of the first and second test signals TS1, TS2 is characterized by the scattering parameter SXX and the other characterizing parameters e₀₁e₁₀, e₁₁. This behavior, which characterizes the analog part ANA, is also present in the simulation operating mode (FIG. 7, FIG. 8). The determined parameters can therefore be used in the simulation operating mode to improve the accuracy of the simulated objects of the first and second electromagnetic signals HF1, HF2.

FIG. 5 shows an amplitude-frequency diagram. The lower curve describes the scattering parameter SXX, which describes the isolation losses from the transmit path to the receive path. It can be seen that the scattering parameter SXX changes over the frequency. The scattering parameters e₀₁e₁₀, SXX also change over the frequency. From this diagram, however, it is not yet possible to draw direct conclusions about the operating parameters of the analog part ANA.

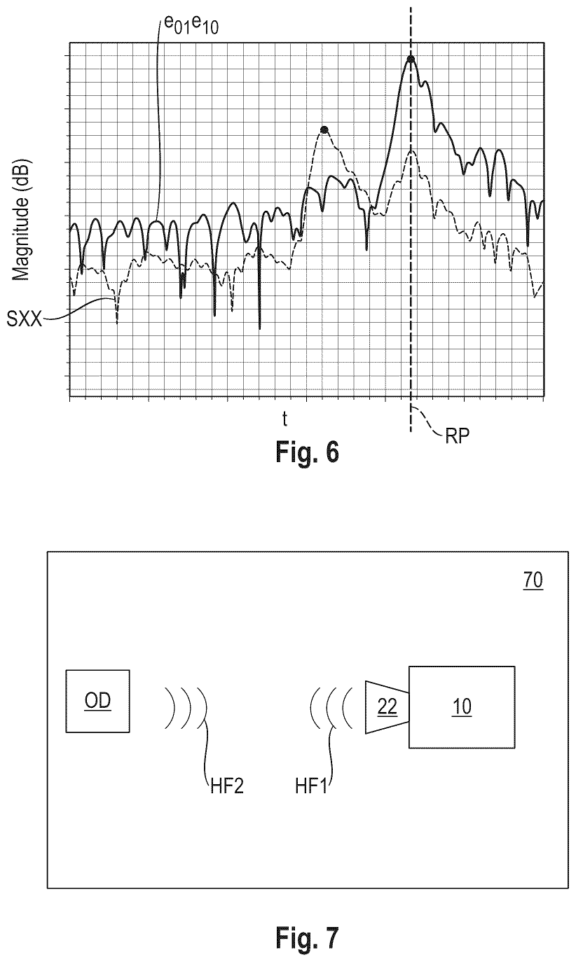

FIG. 6 shows an amplitude-time diagram for the scattering parameter SXX and for one of the other characterizing parameters e₀₁e₁₀. Local maxima of the represented parameters SXX, e₀₁e₁₀ can be seen. Based on the representation of the parameters over time in FIG. 6, visual conclusions can already be drawn about the analog part ANA characterized by them.

It can be seen, for example, that the scattering parameter SXX has two local maxima. The isolation is characterized by the scattering parameter SXX. A maximum means correspondingly large isolation vulnerabilities. It can be seen that a maximum of the scattering parameter SXX lies in the reference plane RP. From this it can be concluded that there is an isolation vulnerability at the output of the analog part ANA. The other maximum of the scattering parameter SXX lies within the analog part ANA. From the exemplary course of the scattering parameter SXX shown above, it can therefore be concluded that there is a point of lower isolation within the analog part ANA.

The other characterizing parameter e₀₁e₁₀ also has a maximum in the reference plane. The maximum curve of the other characterizing parameter e₀₁e₁₀ describes the operating parameters of gain and delay of the system.

FIG. 7 shows a simulation environment 70 showing the transceiver 10 with the antenna 22 for transmitting and receiving the first and second electromagnetic signals HF1 and HF2. Now the object detection sensor OD is included, which sends the second electromagnetic signal HF2 and receives the first electromagnetic signal HF1 in response. The received electromagnetic signal HF1 is perceived by the object detection sensor OD as an echo of its emitted second electromagnetic signal HF2. The echo is perceived as a reflection on simulated objects, for example in road traffic. The object detection sensor OD can be a radar sensor. In the simulation environment 70 shown, the transceiver 10 is in the simulation operating mode. It exchanges the electromagnetic signals HF1, HF2 with the object detection sensor OD. For the object detection sensor OD, an environment with objects is simulated so that it can be tested.

In another block diagram, FIG. 8 shows the transceiver 10 with the test device DIG and the analog part ANA. The transceiver 10 is operated in the simulation operating mode.

The analog part ANA has a transmitting part TX and a receiving part RX as well as a coupler KO. The antenna 22 is connected to the coupler KO, via which the second electromagnetic signal HF2 can be received from the object detection sensor OD and the first electromagnetic signal HF1 can be sent to the object detection sensor.

The received second electromagnetic signal HF2 is received by the receiving part RX and output to the test device via the analog-to-digital converter ADC as the first digital signal DS1.

For the simulation of objects for the object detection sensor OD, the test device DIG acts as a manipulation device. For the simulation of objects, the test device DIG receives the first DS1 digital signal. The first digital signal DS1 is modified by the processor 12 of the test device DIG and output as the second digital signal DS2.

The second digital signal DS2 is fed into the transmitting part TX by means of the digital-to-analog converter DAC and is transmitted by it as the first electromagnetic signal HF1.

The simulation of objects is done by changing the first digital signal in the processor 12. The change is carried out in such a way that it has an effect on the first electromagnetic signal HF1, for example, by a change in phase and/or amplitude, as it would have been caused by an object in road traffic.

In addition, FIG. 8 shows a crosstalk signal 80, since crosstalk can take place between the transmitting part TX and the receiving part RX and can thus cause a disturbance in the functioning of the transceiver 10. Using scattering parameters SXX, this crosstalk signal 80 can be determined during the operation of the transceiver 10 in simulation operating mode. When generating the second digital signal, this may be taken into account and optionally compensated. Compensation can be achieved, for example, by generating a 180° phase-shifted signal, which is capable of canceling or at least reducing the interference signal generated by the crosstalk signal.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A transceiver for transmitting and receiving electromagnetic signals that are intended for exchange with an object detection sensor, the transceiver comprising:
an analog part that has a transmitting part and a receiving part;
wherein a test device is set up to transmit a first test signal to the transmitting part,
wherein the transmitting part is set up to generate a first electromagnetic signal from the first test signal and transmit it,
wherein the receiving part is set up to receive a second electromagnetic signal derived from the first electromagnetic signal, convert it into a second test signal and transmit it to the test device,
wherein the test device is set up to determine at least one parameter characterizing the analog part as a function of the first and the second test signals.

2. The transceiver according to claim 1, wherein the test device is set up to determine and store at least one operating parameter of the analog part as a function of the at least one characterizing parameter, wherein the at least one operating parameter comprises a gain value and/or a delay and/or an isolation.

3. The transceiver according to claim 1, wherein the electromagnetic signals intended for exchange with the object detection sensor are a function of the at least one characterizing parameter and/or the at least one operating parameter.

4. The transceiver according to claim 1, wherein the test device is set up to determine the at least one characterizing parameter via a system identification of the analog part using the first and second test signals.

5. The transceiver according to claim 1, wherein the test device is set up to determine the at least one characterizing parameter in the frequency range.

6. The transceiver according to claim 5, wherein the test device is set up to transform the at least one characterizing parameter from the frequency range to the time range and to determine the at least one operating parameter as a function of the one characterizing parameter transformed into the time range.

7. The transceiver according to claim 1, wherein the second electromagnetic signal is adapted to be derived from the first electromagnetic signal via a predefined reflection standard.

8. The transceiver according to claim 7, wherein the predefined reflection standard comprises an impedance match or an open circuit or a short circuit or a reflection of the first electromagnetic signal on a reflector or on a corner reflector.

9. The transceiver according to claim 1, wherein the transceiver is equipped to determine and/or compensate for a crosstalk signal when exchanging the electromagnetic signals with the object detection sensor as a function of the characterizing parameter.

10. A method for characterizing a transceiver for transmitting and receiving electromagnetic signals, the electromagnetic signals being intended for exchange with an object detection sensor, wherein the transceiver has an analog part, wherein the analog part has a transmitting part and a receiving part, the method comprising:
transmitting, via a test device, a first test signal to the transmitting part;
generating, via the transmitting part, a first electromagnetic signal from the first test signal and sending the first electromagnetic signal;
receiving, via the receiving part, a second electromagnetic signal derived from the first electromagnetic signal and converting the second electromagnetic signal into a second test signal and transmitting the second test signal to the test device;
determining, via the test device, at least one parameter characterizing the analog part as a function of the first and second test signals.

11. The method according to claim 10, wherein, as a function of at least one characterizing parameter, at least one operating parameter is determined, and wherein the at least one operating parameter comprises a gain value and/or a delay and/or an isolation.

12. The method according to claim 10, wherein the at least one characterizing parameter is determined via a system identification of the analog part using the first and second test signals.

13. The method according to claim 10, wherein the at least one characterizing parameter is determined in the frequency range.

14. The method according to claim 13, wherein the at least one characterizing parameter is transformed from the frequency range to the time range, and the at least one operating parameter is determined as a function of the at least one characterizing parameter transformed into the time range.

15. The method according to claim 10, wherein the second electromagnetic signal is derived from the first electromagnetic signal via a predefined reflection standard, and wherein the predefined reflection standard includes an impedance match or an open circuit or a short circuit or a reflection of the first electromagnetic signal on a corner reflector.

16. The method according to claim 15, wherein different predefined reflection standards are defined by the distance of the corner reflector from the transceiver.

17. The method according to claim 15, wherein the method is carried out with a predefined reflection standard or is carried out several times in succession, each time with a different predefined reflection standard.
